(19) United States
(12) Patent Application Publication
(10) Pub. No.: US 2016/0115889 A1
(43) Pub. Date: Apr. 28, 2016

(54) FUEL INJECTION CONTROL SYSTEM OF INTERNAL COMBUSTION ENGINE

(71) Applicant: TOYOTA JIDOSHA KABUSHIKI KAISHA, Toyota-shi, Aichi-ken (JP)

(72) Inventor: Takahiro TSUKAGOSHI, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/893,762

(22) PCT Filed: May 27, 2014
(86) PCT No.: PCT/IB2014/000870

§ 371 Date: Nov. 24, 2015

(30) Foreign Application Priority Data
May 30, 2013 (JP) 2013-113699

(51) Int. Cl. F02D 41/06; F02D 41/04; F02D 41/00

(52) U.S. Cl. CPC F02D 41/062; F02D 41/0025; F02D 41/047

(57) ABSTRACT

A fuel injection control system of an internal combustion engine driven by an alcohol blended fuel includes a controller that controls the amount of the fuel injected from a fuel injection valve. The controller performs injection amount control after start of cranking, when an alcohol concentration of the alcohol blended fuel is higher than a predetermined concentration, so that the amount of the alcohol blended fuel injected from the fuel injection valve in each fuel injection is controlled to be smaller than an amount of the fuel with which an air-fuel ratio becomes a combustible air-fuel ratio, until an initial explosion occurs.

### BACKGROUND OF THE INVENTION

1. Field of the Invention

The invention relates to a fuel injection control system of an internal combustion engine.

2. Description of Related Art

A fuel supply control system of an internal combustion engine is described in Japanese Patent. Application Publication No. 62-178735 (JP 62-178735 A). In the internal combustion engine, alcohol blended fuel (which will be simply called “blended fuel”) is used. In the case where the blended fuel is used (which will be called “in the case of use of the blended fuel”), if the fuel is injected when the engine is started, in the same amount as the fuel injection amount in the case where only gasoline is used (which will be called “in the case of use of gasoline”), the startability of the engine is reduced as compared with the case where gasoline is used. Thus, in the system described in JP 62-178735 A, the fuel injection amount is increased as the alcohol concentration is higher, and the fuel injection amount is increased as the engine temperature is lower, based on the alcohol concentration in the blended fuel and the engine temperature.

In order to cause the initial explosion to occur in the first cycle after start of cranking when the blended fuel is used, it is necessary to make the fuel injection amount larger than that in the case of use of gasoline. However, if the engine temperature is low in this case, a part of the fuel does not evaporate, and the fuel that has not evaporated may remain in the cylinder without burning. In this case, that part of the fuel that remains in the cylinder without burning in the first cycle may remain in the cylinder until the second cycle. Under this situation, if the fuel is also injected in the second cycle, in an amount larger than the fuel injection amount in the case of use of gasoline, a large amount of fuel will exist in the cylinder. In this case, since the engine temperature is elevated due to combustion in the first cycle, a large amount of fuel evaporates, resulting in an excessively rich air-fuel ratio in the cylinder. Therefore, the combustibility is reduced in the second cycle, and, consequently, the engine speed will not increase. The reduction of the combustibility may continue over several cycles following the first cycle. In this case, the engine start-up time will be prolonged.

### SUMMARY OF THE INVENTION

The object of the invention is to achieve a short engine start-up time, in an internal combustion engine that is driven by alcohol blended fuel.

A first aspect of the invention is concerned with a fuel injection control system of an internal combustion engine driven by alcohol blended fuel. The fuel injection control system according to the first aspect of the invention includes a controller that controls an amount of the fuel injected from a fuel injection valve. The controller performs injection amount control after start of cranking, when an alcohol concentration of the alcohol blended fuel is higher than a predetermined concentration, so that the amount of the alcohol blended fuel injected from the fuel injection valve in each fuel injection is controlled to be smaller than an amount of the fuel with which an air-fuel ratio becomes a combustible air-fuel ratio, until an initial explosion occurs. According to the first aspect of the invention, the in-cylinder air-fuel ratio is less likely or unlikely to be excessively rich after the initial explosion. Therefore, a short engine start-up time can be achieved.

The controller may set the predetermined concentration to a higher concentration as the engine temperature is higher. With this arrangement, a shorter engine start-up time can be achieved. Namely, when the engine temperature is high, an alcohol component in the alcohol blended fuel is likely to evaporate. Accordingly, the in-cylinder air-fuel ratio is less likely or unlikely to be excessively rich after the initial explosion, even if the predetermined concentration is set to a higher concentration as the engine temperature is higher. Furthermore, if the predetermined concentration is set to a higher concentration as the engine temperature is higher, an execution region of the injection amount control is reduced. Therefore, an even shorter engine start-up period can be achieved.

The controller may increase the start-time injection amount as the alcohol concentration is higher. In this case, the amount of increase of the start-time injection amount is an amount that makes up for a shortage of an amount of heat generated, due to a shortage of an evaporation amount of the alcohol blended fuel, relative to the amount of heat generated when the alcohol concentration is 0%, and an amount of heat lost due to vaporization of an alcohol component in the alcohol blended fuel.

With the above arrangement, a short engine start-up time can be achieved with higher reliability. Namely, it is necessary to increase the engine speed, so as to complete starting of the engine. To this end, it is necessary to ensure an amount of heat generation sufficient to increase the engine speed. Accordingly, in the case where the alcohol blended fuel is used, the engine speed can be increased with higher reliability, if the start-time injection amount is increased by an amount that makes up for a shortage of the amount of heat generation due to a shortage of the amount of evaporation of the alcohol blended fuel, and an amount of heat lost due to vaporization of the alcohol component in the alcohol blended fuel. Since the shortage of the amount of heat generated by the alcohol blended fuel is considered as the sum of a portion thereof due to the shortage of the amount of evaporation of the alcohol blended fuel, and the amount of heat lost due to vaporization of the alcohol component in the alcohol blended fuel, the amount of increase of the start-up injection amount can be obtained with improved accuracy. Consequently, a short engine start-up time can be achieved with higher reliability.

Also, the controller may perform the injection amount control, only when the alcohol concentration of the alcohol blended fuel is higher than the predetermined concentration, and an engine temperature is lower than a predetermined temperature. With this arrangement, a short engine start-up time can be achieved with higher reliability. Namely, when the engine temperature is low, it is difficult for the alcohol component in the alcohol blended fuel to evaporate. Therefore, the injection amount control should be carried out while the engine temperature is low, so as to achieve a short engine start-up time. Accordingly, if the injection amount control is carried out while the engine temperature is lower than the predetermined temperature, a short engine start-up time can be achieved with higher reliability.

Also, the controller may gradually increase the amount of the alcohol blended fuel injected from the fuel injection valve in each fuel injection, within a range that is smaller than the amount of the fuel with which the air-fuel ratio becomes the combustible air-fuel ratio.

With the above arrangement, a short engine start-up time can be achieved with higher reliability. Namely, the amount of vaporization of the alcohol blended fuel is small immediately after the start of cranking, but the amount of vaporization gradually increases as the engine temperature rises. Namely, the amount of the alcohol blended fuel that is carried over to the next cycle without being vaporized is gradually reduced, and the in-cylinder air-fuel ratio becomes less likely to be excessively rich. Accordingly, if the amount of the alcohol blended fuel injected from the fuel injection valve in each fuel injection is gradually increased within a range that is smaller than the amount of the fuel with which the air-fuel ratio becomes a combustible air-fuel ratio, a short engine start-up time can be achieved with higher reliability.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of an internal combustion engine in which a fuel injection control system according to one embodiment of the invention is used;

FIG. 2 shows one example of map for use in calculation of an increasing correction factor;

FIG. 3 shows one example of map for use in calculation of a reducing correction factor;

FIG. 4 is a graph indicating the relationship between the alcohol concentration and the start-time injection amount when the start-time water temperature is lower than a threshold water temperature;

FIG. 5 is a graph indicating the relationship between the alcohol concentration and the start-time injection amount when the start-time water temperature is, higher than the threshold water temperature;

FIG. 6 is a graph indicating the relationship between the engine temperature and the evaporation rate;

FIG. 7 is a graph indicating the relationship between the start-time water temperature and the evaporated fuel proportion of blended fuel having a 75% concentration of ethanol;

FIG. 8 is a view useful for explaining fuel that is carried over from the first cycle, to the second cycle during starting of the engine;

FIG. 9 is a graph showing changes in the engine speed with time during a start-up period in the case of use of blended fuel when the start-time water temperature is −25° C.;

FIG. 10 is a graph showing a cranking period, start-up combustion period, and changes in the in-cylinder temperature, fuel injection amount, in-cylinder air-fuel ratio, and engine speed with time during a warm-up operation period, under each of conventional gasoline control, conventional blended fuel control, and control of a first embodiment of the invention;

FIG. 11 is a flowchart illustrating a start-up initiating routine of the first embodiment;

FIG. 12 is a flowchart illustrating a fuel injection control routine of the first embodiment;

FIG. 13 is a flowchart illustrating a start-up completion determining routine of the first embodiment; and

FIG. 14A is a graph indicating changes in the fuel injection amount with time under the control of the first embodiment, FIG. 14B is a graph showing changes in the fuel injection amount with time under control of a second embodiment, and FIG. 14C is a graph showing changes in the fuel injection amount with time under control of a third embodiment.

### DETAILED DESCRIPTION OF EMBODIMENTS

Some embodiments of the invention will be described with reference to the drawings. An internal combustion engine that will be described below is a four-cycle, spark-ignition, multi-cylinder (in-line four-cylinder) engine. It is, however, to be understood that this invention may be applied to other types of engines.

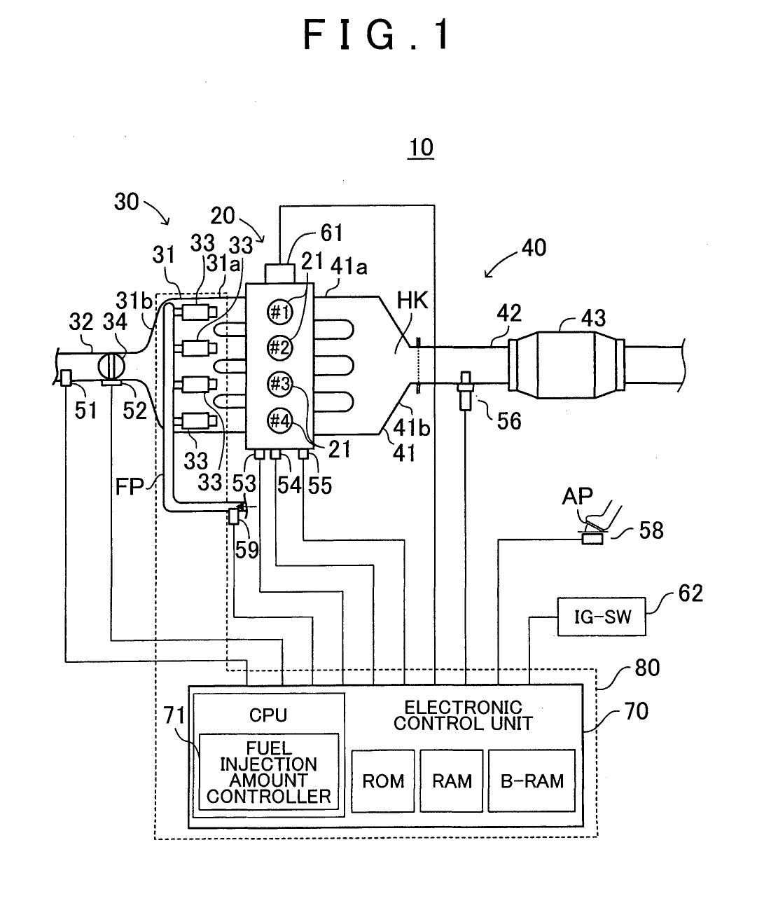

FIG. 1 shows an internal combustion engine 10 in which a fuel injection control system as a first embodiment of the invention is used. The internal combustion engine (which will be simply called “engine”) 10 includes an engine main body 20, an intake system 30, and an exhaust system 40.

The engine main body 20 includes a cylinder block and a cylinder head. The engine main body 20 has a plurality of cylinders (combustion chambers) 21. Each of the cylinders communicates with an intake port (not shown) and an exhaust port (not shown). A communicating portion between the intake port and the combustion chamber 21 is opened and closed by an intake valve (not shown). A communicating portion between the exhaust port and the combustion chamber 21 is opened and closed by an exhaust valve (not shown). An ignition plug (not shown) is mounted in each cylinder 21.

The intake system 30 includes an intake manifold 31, an intake pipe 32, a plurality of fuel injection valves (fuel injectors) 33, and a throttle valve 34. The intake manifold 31 includes a plurality of branch portions 31a and a surge tank 31b. One end of each of the branch portions 31a is connected to a corresponding one of the intake ports. The other end of each branch portion 31a is connected to the surge tank 31b. One end of the intake pipe 32 is connected to the surge tank 31b. An air filter (not shown) is provided at the other end of the intake pipe 32. Each of the intake ports, intake manifold 31, and the intake pipe 32 constitute an intake passage.

The fuel injection valve 33 is provided in each of the intake ports. Namely, one fuel injection valve 33 is mounted corresponding to each of the cylinders 21. The throttle valve 34 is rotatably disposed in the intake pipe 32. The throttle valve 34 is operable to vary the cross-sectional area of the opening of the intake passage. The throttle valve 34 is rotated/driven by a throttle-valve actuator (not shown) within the intake pipe 32.

The exhaust system 40 includes an exhaust manifold 41, an exhaust pipe 42, and a catalyst 43. The exhaust manifold 41 includes a plurality of branch portions 41a and a collecting portion 41b. One end of each of the branch portions 41a is connected to a corresponding one of the exhaust ports. The other end of each branch portion 41a joins the collecting portion 41b. Exhaust gases discharged from the plurality of (four in the first embodiment) cylinders gather in the collecting portion 41b. In the following, the collecting portion 41b will also be called “exhaust collecting portion HK”. The exhaust pipe 42 is connected to the collecting portion 41b. Each of the exhaust ports, exhaust manifold 41, and the exhaust pipe 42 constitute an exhaust passage. The catalyst 43 is disposed in the exhaust pipe 42. The catalyst 43 converts or removes particular components contained in exhaust gas flowing through the exhaust pipe 42.

The engine 10 includes a hot-wire air flow meter 51, a throttle position sensor 52, a water temperature sensor 53, a crank position sensor 54, an intake cam position sensor 55, an accelerator pedal position sensor 58, and an alcohol concentration sensor 59.

The air flow meter 51 outputs a signal indicative of the intake air amount (namely, the mass flow of intake air flowing in the intake pipe 32) Ga. The intake air amount Ga represents the amount of intake air drawn into the engine 10 per unit time. The throttle position sensor 52 outputs a signal indicative of the throttle opening (namely, the opening of the throttle valve 34) TA. The water temperature sensor 53 outputs a signal indicative of the water temperature (namely, the temperature of the coolant of the engine 10) THW. The water temperature THW is a parameter that represents the engine temperature.

The crank position sensor 54 outputs a signal having a narrow pulse each time the crankshaft rotates 10°, and outputs a signal having a wide pulse each time the crankshaft rotates 360°. An electronic control unit 70 that will be described later calculates the engine speed NE, based on these signals. The intake cam position sensor 55 outputs one pulse each time an intake camshaft rotates 90 degrees from a given angle, then rotates 90 degrees, and further rotates 180 degrees. The electronic control unit 70 obtains an absolute crank angle CA relative to the compression top dead center of a reference cylinder (e.g., the first cylinder), based on the signals from the crank position sensor 54 and intake cam position sensor 55. The absolute crank angle CA is set to “0° crank angle” at the compression top dead center of the reference cylinder, and increases up to 720° crank angle according to the rotational angle of the crankshaft. The absolute crank angle CA is set to 0° crank angle again when it reaches 720° crank angle.

The exhaust gas sensor 56 is mounted in the exhaust manifold 41 or the exhaust pipe 42, at a position between the collecting portion 41b (exhaust collecting portion HK) of the exhaust manifold 41 and the catalyst 43. The exhaust gas sensor 56 is an EMF (electromotive force) type oxygen sensor that detects the concentration of oxygen in exhaust gases. The accelerator pedal position sensor 58 outputs a signal indicative of the operation amount Accp (the accelerator pedal operation amount, the position of the accelerator pedal AP) of the accelerator pedal AP operated by the driver. The accelerator pedal operation amount Accp increases as the amount by which the accelerator pedal AP is operated increases.

The alcohol concentration sensor 59 is mounted in a fuel supply pipe FP that connects the plurality of fuel injection valves 33 with a fuel tank (not shown). The alcohol concentration sensor 59 generates a signal E indicative of the concentration of alcohol (ethanol in this embodiment) in the fuel. The alcohol concentration sensor 59 may be, a capacitance sensor that detects the alcohol concentration based on the permittivity of the fuel, or may be an optical sensor that detects the alcohol concentration based on the refractive index and transmittance of the fuel, for example.

The engine 10 also includes a starter 61, and an ignition key switch (IG-SW) 62. The starter 61 drives the engine 10 from the outside, to assist in self-revolution of the engine 10.

The electronic control unit 70 is a well-known microcomputer that consists principally of CPU, ROM in which programs executed by the CPU, tables (maps, functions), constants, etc. are stored in advance, RAM in which the CPU temporarily stores data as needed, backup RAM, interfaces including AD converters, and so forth. The above-indicated sensors are connected to the electronic control unit 70. Also, the electronic control unit 70 is connected to the ignition plugs, fuel injection valves 33, and the throttle-valve actuator 52.

The electronic control unit 70 drives the ignition plug of each cylinder so that an air-fuel mixture is ignited by the ignition plug at a target point in time. The electronic control unit 70 also drives the fuel injection valve 33 for each cylinder so that a target amount of fuel is injected from the fuel injection valve 33 at a target point in time. The electronic control unit 70 also drives the throttle-valve actuator 52 so that the throttle opening TA increases as the accelerator pedal operation amount Accp increases. The electronic control unit 70 also drives the starter 61 when it receives a starter operation request signal from the ignition key switch 62.

The fuel injection control system 80 includes the fuel injection valves 33 and the electronic control unit 70. The electronic control unit 70 includes a fuel injection amount controller 71 in the CPU. The fuel injection control system 80 controls each of the fuel injection valves 33 based on the fuel injection amount determined by the fuel injection amount controller 71.

(Fuel Injection Control During Start-Up Period)

Next, fuel injection control performed during a start-up period will be described. The start-up period is a period from the start of cranking of the engine 10 to start-up completion. More specifically, the start-up period means a period from the start of cranking, to the time when the engine speed reaches a start-up completion speed, or a period from the start of cranking, to the time when a given number of cycles pass after the engine speed reaches the start-up completion speed. In the following description, the alcohol concentration means the concentration of alcohol in blended fuel. Also, cranking period is a period from the start of cranking to the time when the initial explosion occurs.

In the first embodiment, a target fuel injection amount required to ensure desired startability in the case of use of gasoline (namely, when gasoline is used as a fuel that drives the engine 10) is stored as a reference start-time injection amount Qb in the electronic control unit 70.

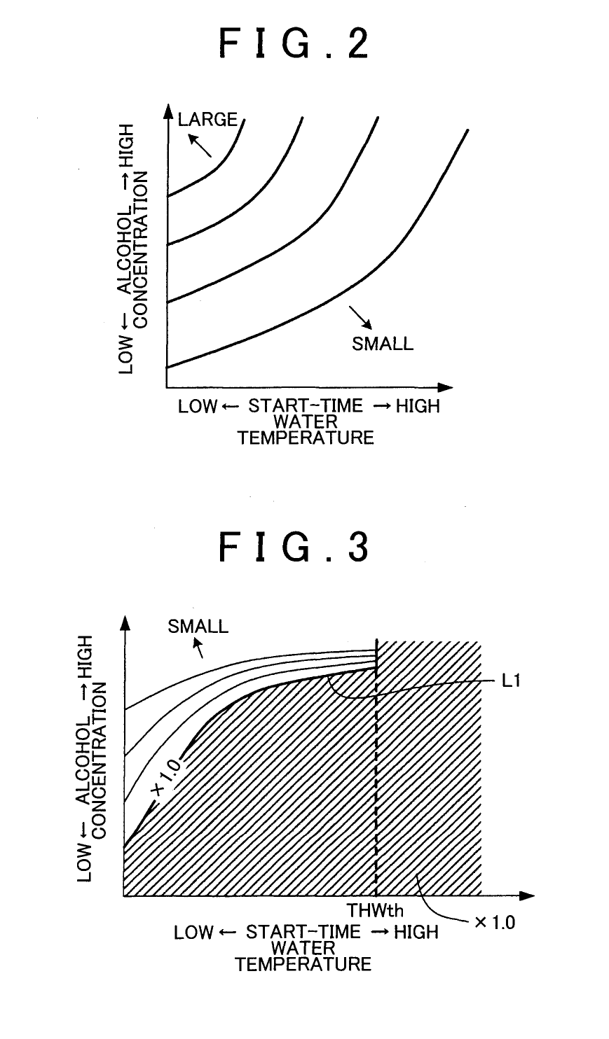

Also, a factor by which the reference start-time injection amount Qb is increased in the case of use of blended fuel (namely, when blended fuel is used as a fuel that drives the engine 10), so as to ensure a cranking period equivalent to the cranking period in the case of use of gasoline, is obtained in advance by experiment, or the like, according to the start-time water temperature and the alcohol concentration. The factor thus obtained is stored in the electronic control unit 70 as an increasing correction factor, in the form of a map in relation to the start-time water temperature and the alcohol concentration, as shown in FIG. 2.

Also, a factor by which the increasing correction factor is reduced so as to ensure desired startability in the case of use of blended fuel is obtained in advance by experiment, or the like, according to the start-time water temperature and the alcohol concentration. The factor thus obtained is stored in the electronic control unit 70 as a reducing correction factor, in the form of a map in relation to the start-time water temperature and the alcohol concentration, as shown in FIG. 3.

During the start-up, period, the increasing correction factor is calculated from the map of FIG. 2, based on the start-time water temperature and the alcohol concentration, and the reducing correction factor is calculated from the map of FIG. 3, based on the start-time water temperature and the alcohol concentration. Then, the reference start-time injection amount Qb is multiplied by a value that is a product of the reducing correction factor and the increasing correction factor. In this manner, the start-time injection amount (namely, the target fuel injection amount during the start-up period) in the case of use of blended fuel is calculated. Then, the fuel injection valve 33 is operated so that the thus calculated start-time injection amount of fuel is injected in suitable timing.

(Increasing Correction Factor)

The increasing correction factor tends to be a smaller value as the start-time water temperature is higher. Also, the increasing correction factor is equal to “1” when the alcohol concentration is 0%, and is equal to a value larger than “1” when the alcohol concentration is higher than 0%. The increasing correction factor becomes a larger value as the alcohol concentration is higher.

(Reducing Correction Factor)

The reducing correction factor is equal to “1” when the start-time water temperature is equal to or lower than a threshold water temperature THWth, and the alcohol concentration is equal to or lower than a threshold concentration. The reducing correction factor is larger than “0” and smaller than “1” when the start-time water temperature is equal to or lower than the threshold water temperature THWth and the alcohol concentration is higher than the threshold concentration. The reducing correction factor becomes a smaller value as the alcohol concentration is higher, under a condition that the start-time water temperature is equal to a given temperature that is equal to or lower than the threshold water temperature THWth. More specifically, when the start-time water temperature is equal to or lower than the threshold water temperature, and the alcohol concentration is higher than the threshold concentration, the reducing correction factor is determined so that the start-time injection amount calculated using this factor makes the in-cylinder air-fuel ratio leaner than the air-fuel ratio within a combustible range (namely, the air-fuel ratio within a range in which the fuel evaporated in the cylinder burns, which will be called “combustible air-fuel ratio”), in the initial fuel injection after the start of cranking.

The reducing correction factor is equal to “1” when the start-time water temperature is equal to or higher than the threshold water-temperature THWth. The threshold concentration is determined according to the start-time water temperature, and varies along a line indicated by solid line L 1 in FIG. 3, according to the start-time water temperature. More specifically, the threshold concentration is lower as the start-time water temperature is lower.

(Relationship 1 Between Alcohol Concentration and Start-Time Injection Amount)

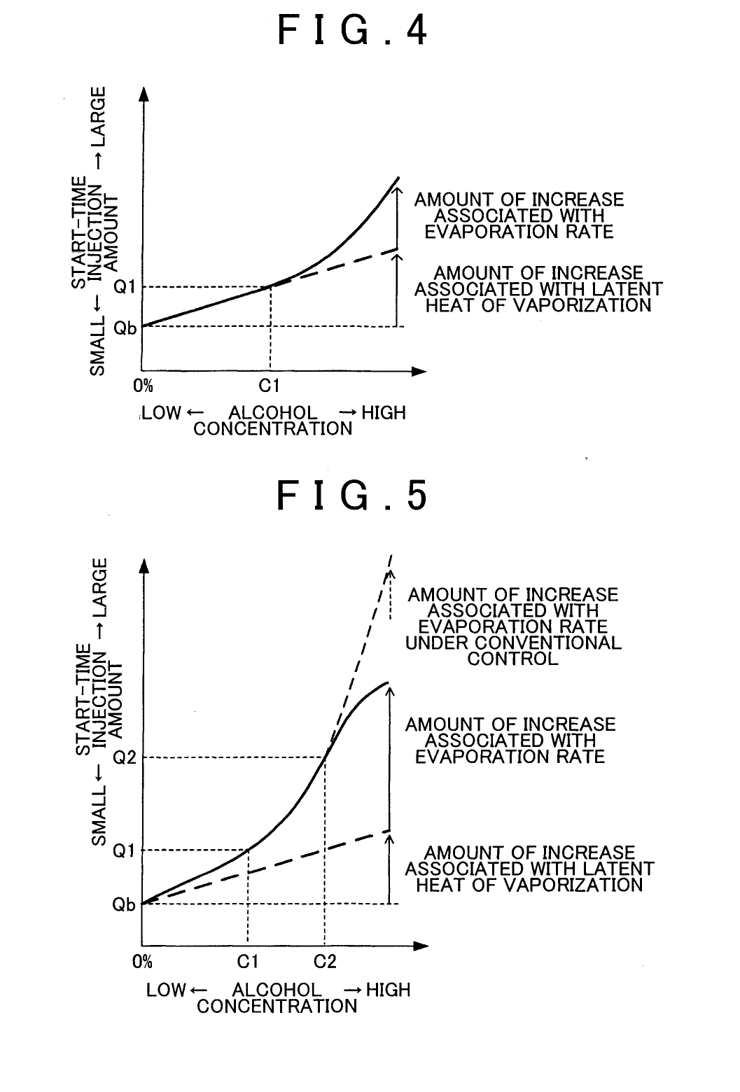

According to the first embodiment, when the start-time water temperature is higher than the threshold water temperature THWth in the case of use of the blended fuel, the alcohol concentration and the start-time injection amount have a relationship as shown in FIG. 4 during the start-up period.

Namely, when the alcohol concentration is 0%, namely, when the fuel consists solely of gasoline, the start-time injection amount is the same as the start-time injection amount in the case of use of gasoline (namely, the reference start-time injection amount Qb). When the alcohol concentration is within the range from 0% to a certain concentration (which will be called “first concentration”) C1, the start-time injection amount linearly increases from the reference start-time injection amount Qb to a certain amount (which will be called “first start-time injection amount”) Q1 as the alcohol concentration increases. Then, when the alcohol concentration is higher than the first concentration C1, the start-time injection amount quadratically increases from the first start-time injection amount Q1 as the alcohol concentration increases.

Accordingly, it may be stated, in other words, that the increasing correction factor and the reducing correction factor are determined so that the alcohol concentration and the target fuel injection amount have the relationship as indicated in FIG. 4, during the start-up period, when the start-time water temperature is higher than the threshold water temperature THWth.

The amount of increase of the start-time injection amount with increase of the alcohol concentration is the sum of the amount of increase associated with latent heat of vaporization, and the amount of increase associated with the evaporation rate. The amount of increase associated with latent heat of vaporization is the amount of increase of the start-time injection amount for making up for a shortage of the amount of heat generated, due to large latent heat of vaporization of alcohol. Namely, the latent heat of vaporization of alcohol is larger than that of gasoline. Due to the large latent heat of vaporization of alcohol, the amount of heat generated in the case of use of the blended fuel is smaller than the amount of heat generated in the case of use of gasoline. The amount of increase for making up for the shortage of the heat generated, due to the large latent heat of vaporization of alcohol, is the above-mentioned amount of increase associated with latent heat of vaporization. On the other hand, the amount of increase associated with the evaporation rate is the amount of increase for making up for a shortage of the amount of heat generated, due to the low evaporation rate of alcohol. Namely, the evaporation rate of alcohol is lower than that of gasoline. Due to the low evaporation rate of alcohol, the amount of heat generated in the case of use of the blended fuel is smaller than the amount of heat generated in the case of use of gasoline. The amount of increase for making up for the shortage of the heat generated, due to the low evaporation rate of alcohol, is the above-mentioned amount of increase associated with the evaporation rate.

In the example as shown in FIG. 4, the amount of increase associated with latent heat of vaporization is equal to “0” when the alcohol concentration is 0%, and linearly increases as the alcohol concentration increases. On the other hand, the amount of increase associated with the evaporation rate is equal to “0” when the alcohol concentration is within the range from 0% to the first concentration C1, and quadratically increases with increase of the alcohol concentration when the alcohol concentration is higher than the first concentration C1. Accordingly, the first concentration C1 may be said to be the smallest concentration of alcohol at which the amount of increase associated with the evaporation rate appears.

(Relationship 2 Between Alcohol Concentration and Start-Time Injection Amount)

According to the first embodiment, when the start-time water temperature is lower than the threshold water temperature THWth in the case where the blended fuel is used, the alcohol concentration and the target fuel injection amount have a relationship as shown in FIG. 5 during the start-up period.

Namely, when the alcohol concentration is 0%, namely, when the fuel consists solely of gasoline, the start-time injection amount is the same as the reference start-time injection amount (namely, the start-time injection amount in the case of use of gasoline) Qb. When the alcohol concentration is within the range from 0% to a certain concentration (which will be called “first concentration”) C1, the start-time injection amount linearly increases from the reference start-time injection amount Qb to a certain amount (which will be called “first start-time injection amount”) Q1 as the alcohol concentration increases. When the alcohol concentration is within the range from the first concentration C1 to a certain concentration (that is higher than the first concentration C1, and will be called “second concentration”) C2, the start-time injection amount quadratically increases from the first start-time injection amount Q1 to a certain amount (which will be called “second start-time injection amount”) Q2 as the alcohol concentration increases. When the alcohol concentration is higher than the second concentration C2, the start-time injection amount increases from the second start-time injection amount Q2 according to an inverse quadratic function as the alcohol concentration increases. Namely, the rate of increase of the start-time injection amount when the alcohol concentration is higher than the second concentration C2 is smaller than the rate of increase of the start-time injection amount when the alcohol concentration is within the range between the first concentration C1 and the second concentration C2.

Accordingly, it may be stated, in other words, that the increasing correction factor and the reducing correction factor are determined so that the alcohol concentration and the target fuel injection amount have the relationship as indicated in FIG. 5, during the start-up period, when the start-time water temperature is lower than the threshold water temperature THWth.

In the example as shown in FIG. 5, the amount of increase associated with latent heat of vaporization is equal to “0” when the alcohol concentration is 0%, and linearly increases as the alcohol concentration increases. On the other hand, the amount of increase associated with the evaporation rate is equal to “0” when the alcohol concentration is equal to 0%, and linearly increases with increase of the alcohol concentration when the alcohol concentration is within the range from 0% to the first concentration C1. Then, the amount of increase associated with the evaporation rate quadratically increases with increase of the alcohol concentration when the alcohol concentration is within the range from the first concentration C1 to the second concentration C2, and increases according to an inverse quadratic function with increase of the alcohol concentration when the alcohol concentration is higher than the second concentration C2. Accordingly, the first concentration C1 may be said to provide a boundary between a region of alcohol concentration in which the amount of increase associated with the evaporation rate linearly increases with increase of the alcohol concentration, and a region of alcohol concentration in which the amount of increase quadratically increases. Also, the second concentration C2 may be said to provide a boundary between the region of alcohol concentration in which the amount of increase associated with the evaporation rate quadratically increases with increase of the alcohol concentration, and a region of alcohol concentration in which the amount of increase increases, according to an inverse quadratic function.

### Effect of First Embodiment

According to the first embodiment, a short engine start-up time can be achieved, in the internal combustion engine in which the blended fuel is used. The reason will be described below. In the following, the reason will be explained with respect to the case where alcohol in the blended fuel is ethanol, and the concentration of ethanol is 75%, for example. The start-up time is a length of time it takes from the start of cranking to start-up completion.

(Evaporation Characteristics of Ethanol and Gasoline)

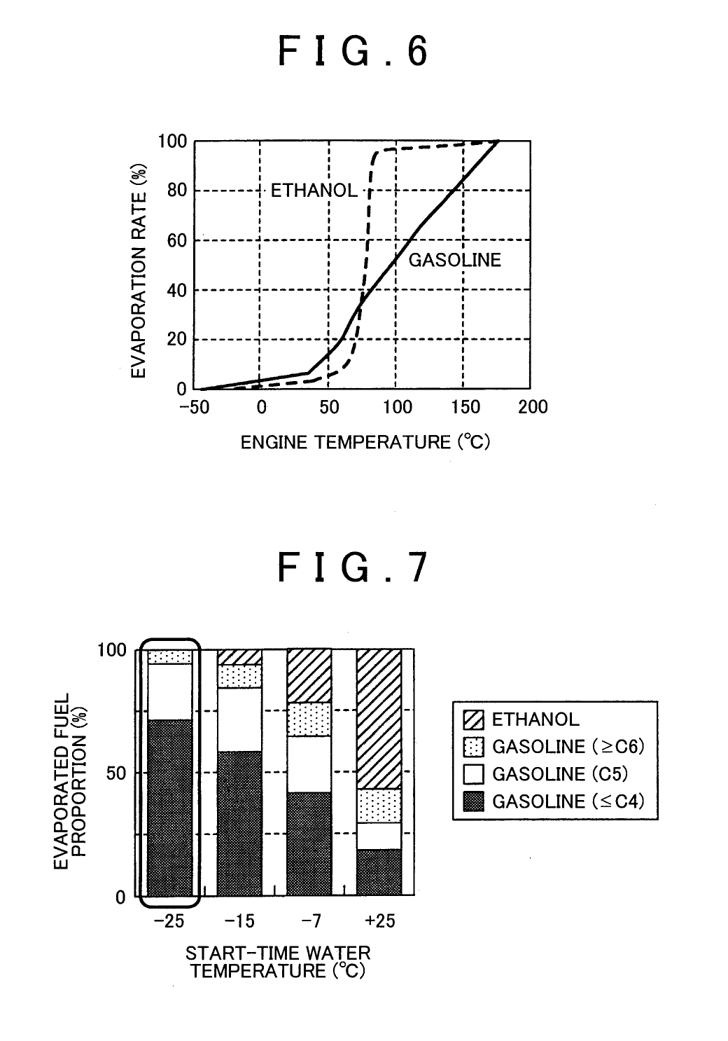

FIG. 6 shows the relationship between the engine temperature (the temperature of the engine coolant) and the evaporation rate of ethanol, and the relationship between the engine temperature and the evaporation rate of gasoline. The evaporation rate is the ratio of evaporated fuel to the total amount of fuel.

As shown in FIG. 6, the evaporation rate of ethanol is substantially equal to 0% when the engine temperature is lower than about −15° C., and is several % even when the engine temperature is within the range from about −15° C. to about 50° C. When the engine temperature reaches about 50° C., the evaporation rate of ethanol starts increasing, and then gradually increases toward about 10% as the engine temperature increases. Then, when the engine temperature reaches 78° C. that is the boiling point of ethanol, the evaporation rate of ethanol jumps straight to 95%, and then increases toward 100% as the engine temperature increases. Then, the evaporation rate of ethanol reaches 100% when the engine temperature reaches about 175° C.

Although not shown in FIG. 6, ethanol actually evaporates slightly even at an extremely low temperature around −15° C. This may be because the in-cylinder temperature increases due to compression heat during a period up to ignition (a period from the intake stroke to the compression stroke), and the fuel injected from the fuel injection valve at this time flows into the combustion chamber, so that ethanol evaporates when receiving energy of the compression heat.

On the other hand, since gasoline is a blended fuel of several hundreds of hydrocarbon components, it contains components that can evaporate even when the engine temperature is lower than about −15° C. Therefore, the evaporation rate of gasoline increases almost proportionally as the engine temperature increases from an extremely low temperature region equal to or below about −15° C. Then, the evaporation rate of gasoline reaches 100% when the engine temperature reaches about 175° C.

(Start-Time Water Temperature and Evaporated Fuel Proportion)

Owing to the above-described differences between the evaporation characteristic of ethanol and the evaporation characteristic of gasoline, the start-time water temperature and the evaporated fuel proportion have a relationship as shown in FIG. 7. The evaporated fuel proportion is the proportion of ethanol or gasoline contained in the evaporated fuel as a part of the blended fuel.

As shown in FIG. 7 by way of example, the proportion of ethanol in the evaporated fuel of the fuel whose ethanol concentration is 75% is about 60% when the start-time water temperature is 25° C., and is about 25% when the start-time water temperature is −7° C. The same proportion of ethanol is about 6% when the start-time water temperature is −15° C., and is substantially equal to 0% when the start-time temperature is −25° C. Since ethanol evaporates slightly when the start-time temperature is −25° C., the start-time injection amount in the case of use of the blended fuel needs to be made at least larger than the start-time injection amount in the case of use of gasoline, so that the cranking time in the case of use of the blended fuel becomes equivalent to the cranking time in the case of use of gasoline.

(Start-Time Injection Amount and Cranking Period)

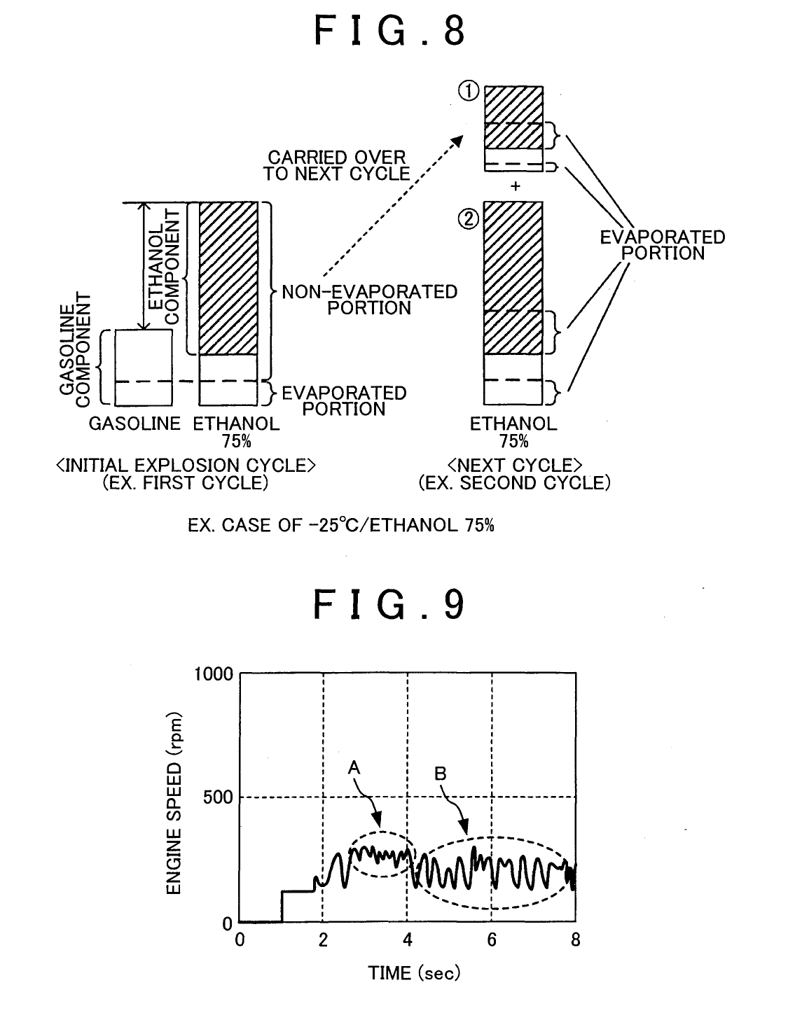

However, research by the inventor of this invention has found that it is not desirable to make the start-time injection amount in the case of use of the blended fuel significantly larger than the start-time injection amount (which will be called “first predetermined amount”) in the case of use of gasoline, as in the related art, from the viewpoint of assurance of desired startability. Namely, even when the start-time water temperature is −25° C., and the blended fuel is injected from the fuel injection valve 33 in the start-time injection amount (which will be called “second predetermined amount”) that is significantly larger than the start-time injection amount in the case of use of gasoline, most of the evaporated fuel, in the blended fuel injected in the intake stroke of the first cycle after start of cranking, is gasoline, as shown in FIG. 8. Accordingly, the remaining gasoline and substantially the entire amount of ethanol remains in the cylinder, without burning in the expansion stroke of the first cycle. Then, the remaining fuel is discharged into the exhaust passage during the exhaust stroke of the first cycle, or is carried over to the second cycle while remaining in the cylinder, as shown in FIG. 8.

If the blended fuel is injected in the amount (second predetermined amount) significantly larger than the start-time injection amount in the case of use of gasoline, in the intake stroke of the second cycle, the blended fuel carried over from the first cycle to the second cycle is added to the blended fuel thus injected, and the in-cylinder air-fuel ratio becomes richer than the assumed air fuel ratio (namely, the air-fuel ratio in the case where no blended fuel is carried over from the first cycle to the second cycle). Further, in the second cycle, the in-cylinder temperature is increased by more than a small degree due to combustion in the first cycle; therefore, the evaporation rate of the blended fuel is increased. Therefore, the in-cylinder air-fuel ratio becomes excessively richer than the assumed air-fuel ratio. As a result, the combustibility of the evaporated fuel is reduced, and the output torque becomes smaller than the assumed torque (namely, the output torque in the case where the in-cylinder air-fuel ratio is equal to the assumed air-fuel ratio). Therefore, the engine speed not only fails to increase to the assumed speed (namely, the engine speed in the case where the in-cylinder air-fuel ratio is equal to the assumed air-fuel ratio), but hardly increases. Then, in the second cycle, too, a part of the blended fuel is carried over to the third cycle, as in the case of the first cycle. Then, this phenomenon continues in the third and subsequent cycles.

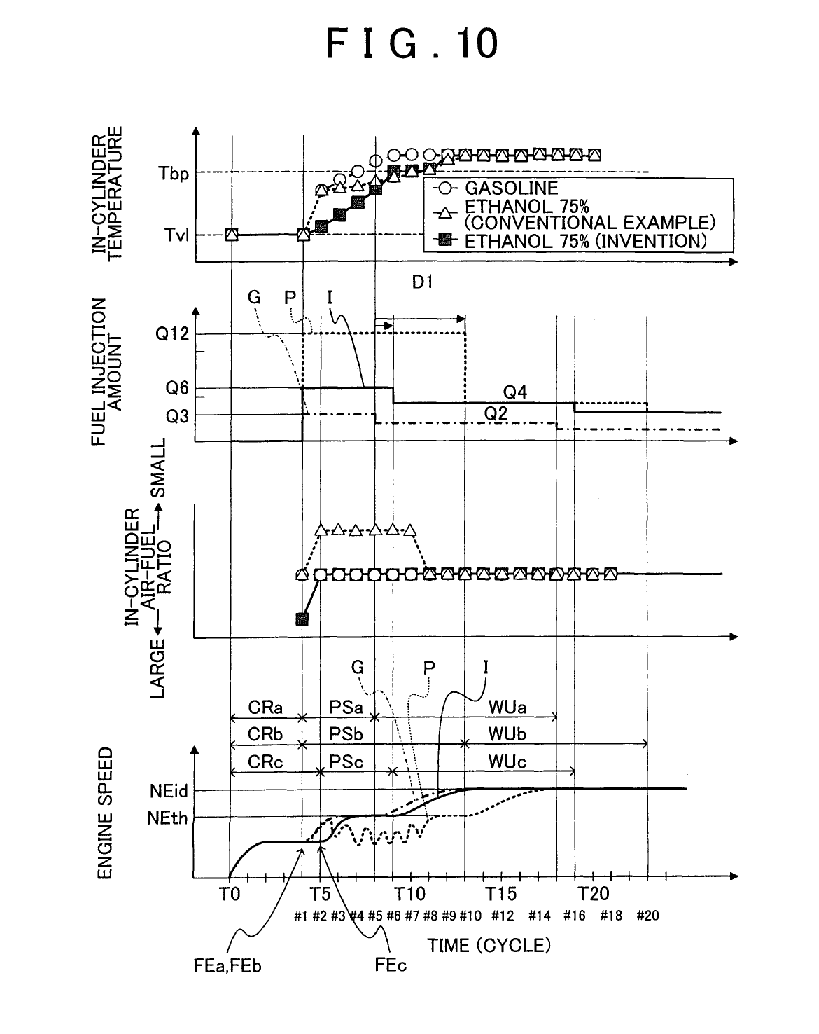

Therefore, the engine speed not only fails to increase as expected, but hardly increases, as indicated by reference symbols A and B in FIG. 9. Consequently, the start-up time is prolonged.

FIG. 9 shows an example in which the ignition key switch is turned on at time 0, and detection of initial conditions, such as cylinder discrimination, is performed for one second from time 0. In this example, cranking is started one second after time 0, and the initial explosion occurs two seconds after time 0.

(Startability According to First Embodiment)

On the other hand, according to the first embodiment, when the start-time water temperature is −25° C., the start-up injection amount of the blended fuel is set to an amount (which will be called “third predetermined amount”) that is smaller than the above-indicated second predetermined amount, during the start-up period. As described above, the third predetermined amount is determined so that the in-cylinder air-fuel ratio becomes leaner than the combustible air-fuel ratio in the initial fuel injection after the start of cranking. Accordingly, the initial explosion does not occur in the first cycle. However, the amount of the blended fuel that is carried over from the first cycle to the second cycle is small. Therefore, in the second and subsequent cycles, the amount of fuel carried over from the previous cycle is small, and the start-time injection amount in the current cycle is small; therefore, the in-cylinder air-fuel ratio becomes the combustible air-fuel ratio in any of these cycles, and then continues to be kept at the combustible air-fuel ratio, before the in-cylinder air-fuel ratio becomes richer than the combustible air-fuel ratio in any of these cycles. As a result, the engine speed continuously increases, and a short start-up time is achieved.

(Comparison of Start-Up Time)

The start-up time under control of the first embodiment, conventional gasoline control, and conventional blended fuel control will be described with reference to FIG. 10. FIG. 10 shows changes in the in-cylinder temperature, fuel injection amount, in-cylinder air-fuel ratio, and the engine speed, with respect to time, under the control of the first embodiment, conventional gasoline control, and the conventional blended fuel control. In FIG. 10, solid line (I) indicates changes under the control of the first embodiment, and one-dot chain line (G) indicates changes under the conventional gasoline control, while dotted line (P) indicates changes under the conventional blended fuel control. The start-up water temperature is −25° C. In any of the cases, cranking is started at time TO, and the initial fuel injection is performed at time T4. Also, the initial fuel injection is conducted in the first cycle. In the following description, the fuel injection amount controlled until start-up completion corresponds to the above-described start-time injection amount.

(1) Conventional Gasoline Control According to the conventional gasoline control, the fuel is injected in the injection amount Q3, in the first cycle (=time T4). Although the in-cylinder temperature is extremely low at this time, the evaporation rate of gasoline is relatively high, and therefore, the in-cylinder air-fuel ratio becomes an air-fuel ratio within the combustible range (namely, an air-fuel ratio within a range in which evaporated fuel burns, which ratio will be called “combustible air-fuel ratio”). Therefore, the evaporated fuel burns with high combustibility, and the initial explosion FEa occurs. Then, the engine speed and the in-cylinder temperature largely increase due to the initial explosion. In FIG. 10, reference symbol CRa denotes a period from time TO at which cranking starts to, time T4 at which the initial explosion occurs. This period is the cranking period under the conventional gasoline control.

Then, in the second cycle (=time T5), too, the fuel is injected in the injection amount Q3. When gasoline is used as the fuel, substantially no fuel is carried over from the first cycle to the second cycle. Accordingly, in the second cycle, too, the in-cylinder, air-fuel ratio becomes a combustible air-fuel ratio, and therefore, the evaporated fuel burns with high combustibility. Accordingly, the engine speed and the in-cylinder temperature increase.

Then, in the third cycle (=time T6), the engine speed reaches the start-up completion speed NEth (e.g., 700 rpm). In the following cycles, too, the fuel injection amount is kept equal to the injection amount Q3, and the evaporated fuel burns with high combustibility; therefore, the engine speed is stably kept at the start-up completion speed.

Then, the engine speed is stably kept at the start-up completion speed until a given number of cycles pass (namely, from the third cycle to the fifth cycle) from the time when the engine speed reaches the start-up completion speed NEth. Thus, it is determined that starting of the engine is completed in the fifth cycle (=time T8). In FIG. 10, reference symbol PSa denotes a period from time T4 at which the initial explosion FEa occurs to start-up completion time T8, and this period is a start-up combustion period under the conventional gasoline control.

Once it is determined that starting of the engine is completed, the fuel injection amount is controlled to an injection amount Q2 that is required to stably keep the engine speed at the idle speed NEid (namely, the speed at which the engine can operate by itself). The injection amount Q2 is smaller than the injection amount Q3. Namely, the fuel injection amount is reduced after the start-up combustion period. However, even if the fuel injection amount is reduced, the in-cylinder temperature is high, and the evaporated fuel burns with high combustibility; therefore, the engine speed and the in-cylinder temperature gradually increase.

Then, in the ninth cycle (=time T12), the engine speed reaches the idle speed NEid. In the following cycles, the fuel injection amount is kept equal to the injection amount Q2, and the evaporated fuel burns with high combustibility. Accordingly, the engine speed is stably kept at the idle speed.

The engine speed is stably kept at the idle speed until a given number of cycles pass (namely, from the ninth cycle to the fifteenth cycle) from the time when the engine speed reaches the idle speed NEid. Thus, in the fifteenth cycle (=time T18), the operating state of the engine shifts to a normal operating state. In FIG. 10, reference symbol WUa denotes a period from start-up completion time T8 to time T18 of shift to the normal operating state, and this period is a warm-up operation period under the conventional gasoline control.

(2) Conventional Blended Fuel Control According to the conventional blended fuel control, the fuel is injected in the injection amount Q12, in the first cycle (=time T4). The fuel injection amount Q12 is significantly larger than the injection amount Q3 of the first cycle under the conventional gasoline control.

Although the in-cylinder temperature is extremely low, and the evaporation rate of the blended fuel is low, in the first cycle, a significantly large amount of fuel is injected, and the in-cylinder air-fuel ratio becomes a combustible air-fuel ratio. Therefore, the evaporated fuel burns with high combustibility, and the initial explosion FEb occurs. Then, the engine speed and the in-cylinder temperature largely increase due to the initial explosion. In FIG. 10, reference symbol CRb denotes a period from time TO of start of cranking to time T4 of occurrence of the initial explosion. This period is the cranking period under the conventional blended fuel control.

Then, in the second cycle (=time T5), too, the fuel is injected in the injection amount Q12. Since the fuel injection amount of the first cycle is significantly large, under, the conventional blended fuel control, a large amount of fuel is carried over from the first cycle to the second cycle. Furthermore, the fuel injection amount of the second cycle is also significantly large. Therefore, the in-cylinder air-fuel ratio does not become a combustible air-fuel ratio in the second cycle. More specifically, the in-cylinder air-fuel ratio becomes smaller than the lower limit of the combustible range, namely, becomes an excessively rich air-fuel ratio. Accordingly, in the second cycle, the evaporated fuel burns, but it burns with low combustibility. Consequently, the engine speed does not increase, and the in-cylinder temperature hardly increases.

Then, in the third cycle (=time T6), too, the fuel is injected in the injection amount Q12. At this time, too, a large amount of fuel is carried over from the second cycle to the third cycle, and the fuel injection amount of the third cycle is also significantly large; therefore, the in-cylinder air-fuel ratio does not become a combustible air-fuel ratio. Accordingly, the evaporated fuel burns, but it burns with low combustibility. Consequently, the engine speed does not increase, and the in-cylinder temperature hardly increases.

In the fourth cycle and subsequent cycles, the fuel injection amount is kept equal to the injection amount Q12. Therefore, the in-cylinder air-fuel ratio does not become a combustible air-fuel ratio, and the evaporated fuel burns only with low combustibility; therefore, the engine speed does not increase. However, since not a small amount of evaporated fuel burns, the in-cylinder temperature gradually increases, and the in-cylinder temperature reaches the boiling point Tbp of the ethanol component in the seventh cycle (=time T10). Then, in the seventh cycle, the evaporated fuel burns with high combustibility. Accordingly, the engine speed increases, and the in-cylinder temperature also increases, as a matter of course.

In the eighth cycle (=time T11) and subsequent cycles, the fuel injection amount is kept equal to the injection amount Q12. However, since the in-cylinder air-fuel ratio becomes a combustible air-fuel ratio, the evaporated fuel burns with high combustibility, and the engine speed and the in-cylinder temperature increase. Since the in-cylinder temperature reaches the boiling point of the ethanol component in the seventh cycle, and the evaporated fuel burns with high combustibility, the amount of fuel that is carried over from the seventh cycle to the eighth cycle is small.

Then, in the ninth cycle (=time T12), the engine speed reaches the start-up completion speed NEth. Subsequently, the fuel injection amount is kept equal to the injection amount Q12, and the evaporated fuel burns with high combustibility; therefore, the engine speed is stably kept at the start-up completion speed.

The engine speed is stably kept at the start-up completion speed until a given number of cycles pass (namely, from the ninth cycle to the tenth cycle) from the time when the engine speed reaches the start-up completion speed NEth. Thus, it is determined in the tenth cycle (=time T13) that starting of the engine is completed. In FIG. 10, reference symbol PSb denotes a period from time T4 of occurrence of the initial explosion FEb to start-up completion time T13, and this period is a start-up combustion period under the conventional blended fuel control.

Once it is determined that starting of the engine is completed, the fuel injection amount is controlled to an injection amount Q4 that is required to stably keep the engine speed at the idle speed NEid. The injection amount Q4 is smaller than the injection amount Q12. Namely, the fuel injection amount is reduced after the start-up combustion period. However, even if the fuel injection amount is reduced, the in-cylinder temperature is high, and the evaporated fuel burns with high combustibility. Accordingly, the engine speed gradually increases.

Then, in the fifteenth cycle (=time T18), the engine speed reaches the idle speed NEid. In the following cycles, the fuel injection amount is kept equal to the injection amount Q4, and the evaporated fuel burns with high combustibility. Accordingly, the engine speed is stably kept at the idle speed.

The engine speed is stably kept at the idle speed until a given number of cycles pass (namely, from the fifteenth cycle to the twentieth cycle) from the time when the engine speed reaches the idle speed NEid. Thus, in the twentieth cycle (=time T23), the operating state of the engine shifts to a normal operating state. In FIG. 10, reference symbol WUb denotes a period from start-up completion time T13 to time T23 of shift to the normal operating state, and this period is a warm-up operation period under the conventional gasoline control.

(3) Control of First Embodiment According to the control of the first embodiment, the fuel is injected in the injection amount Q6 in the first cycle (=time T4). The injection amount Q6 is larger than the injection amount Q3 of the first cycle under the conventional gasoline control, and is smaller than the injection amount Q12 of the first cycle under the conventional blended fuel control.

In the first cycle, the in-cylinder temperature is extremely low, and the evaporation rate of the blended fuel is low, while the fuel injection amount is relatively small; therefore, the in-cylinder air-fuel ratio does not become a combustible air-fuel ratio. More specifically, the in-cylinder air-fuel ratio becomes larger (or leaner) than the upper limit of the combustible range. Accordingly, in the first cycle, the evaporated fuel hardly burns, and no initial explosion occurs; as a result, the engine speed does not increase so much. However, the in-cylinder temperature rises since not a small amount of evaporated fuel burns.

Then, in the second cycle (=time T5), too, the fuel is injected in the injection amount Q6. Under the control of the first embodiment, the amount of fuel that is carried over from the first cycle to the second cycle is small since the fuel injection amount of the first cycle is small, and the fuel injection amount of the second cycle is also small; therefore, the in-cylinder air-fuel ratio becomes a combustible air-fuel ratio in the second cycle. Accordingly, the evaporated fuel burns with high combustibility, and the initial explosion FEc occurs. Owing to the initial explosion, the engine speed and the in-cylinder temperature largely increase. In FIG. 10, reference symbol CRc denotes a period from time TO of start of cranking to time T5 of occurrence of the initial explosion, and this period is a cranking period under the control of the first embodiment.

Then, in the third cycle (=time T6), too, the fuel is injected in the injection amount Q6. At this time, too, the amount of fuel that is carried over from the second cycle to the third cycle is small; therefore, the in-cylinder air-fuel ratio becomes a combustible air-fuel ratio. Accordingly, the evaporated fuel burns with high combustibility, and the engine speed and the in-cylinder temperature largely increase.

Then, in the fourth cycle (=time T7), the engine speed reaches the start-up completion speed NEth. Subsequently, the fuel injection amount is kept equal to the injection amount Q6, and the evaporated fuel burns with high combustibility; therefore, the engine speed is stably kept at the start-up completion speed.

Then, the engine speed is stably kept at the start-up completion speed until a given number of cycles pass (namely, from the fourth cycle to the sixth cycle) from the time when the engine speed reaches the start-up completion speed NEth. Thus, it is determined in the sixth cycle (=time T9) that starting of the engine is completed. In FIG. 10, reference symbol PSc denotes a period from time T5 of occurrence of the initial explosion FEc to start-up completion time T9, and this period is a start-up combustion period under the control of the first embodiment. In the example shown in FIG. 10, the in-cylinder temperature becomes close to the boiling point Tbp of the ethanol component in the fifth cycle (=time T8), and reaches the boiling point Tbp of the ethanol component in the sixth cycle (=time T9).

Once it is determined that starting of the engine is completed, the fuel injection amount is controlled to an injection amount Q4 that is required to stably keep the engine speed at the idle speed NEid. The injection amount Q4 is smaller than the injection amount Q6. Namely, the fuel injection amount is reduced after the start-up combustion period. However, even if the fuel injection amount is reduced, the in-cylinder temperature is relatively high, and the evaporated fuel burns with high combustibility. Accordingly, the engine speed gradually increases.

Then, in the tenth cycle (=time T13), the engine speed reaches the idle speed NEid. In the following cycles, the fuel injection amount is kept at the injection amount Q4, and the evaporated fuel burns with high combustibility. Accordingly, the engine speed is stably kept at the idle speed.

The engine speed is stably kept at the idle speed until a given number of cycles pass (namely, from the tenth cycle to the sixteenth cycle) from the time when the engine speed reaches the idle speed NEid. Thus, in the sixteenth cycle (=time T19), the operating state of the engine shifts to a normal operating state. In FIG. 10, reference symbol WUc denotes a period from start-up completion time T9 to time T19 of shift to the normal operating state, and this period is a warm-up operation period under the control of the first embodiment.

Thus, according to the first embodiment, the start-up completion time (=time T9) is later than the start-up completion time (=time T8) under the conventional gasoline control, but is significantly earlier than the start-up completion time (=time T13) under the conventional blended fuel control. Also, the start-up combustion period PSc is substantially equal to the start-up combustion period PSa under the conventional gasoline control, and is significantly shorter than the start-up combustion period PSb under the conventional blended fuel control. Accordingly, the start-up time under the control of the first embodiment is slightly longer than the start-up time under the conventional gasoline control, but is significantly shorter than the start-up time under the conventional blended fuel control.

(Start-Up Initiation Flow)

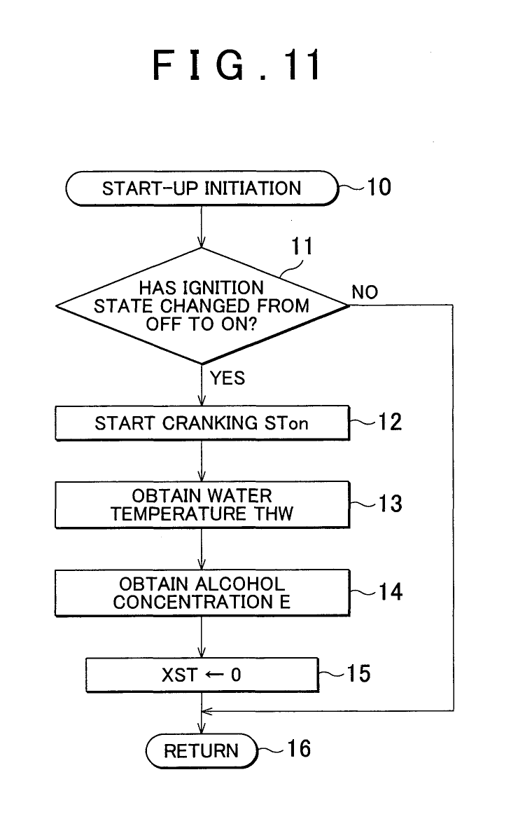

One example of start-up initiation flow of the first embodiment will be described. The example of flow, i.e., a start-up initiating routine, is illustrated in FIG. 11. The CPU repeatedly executes the start-up initiating routine of FIG. 11 at regular intervals, in synchronization with time intervals of interrupt requests of the CPU. The CPU starts the routine from step 10 at the right time, and determines in step 11 whether the state of ignition IG has changed from OFF to ON. The state of ignition IG changes from OFF to ON when the ignition key switch 62 is operated so as to start the engine 10.

If it is determined in step 11 that the state of ignition IG has changed from OFF to ON, namely, if the CPU makes an affirmative decision (YES) in step 11, it executes step 12 through step 15 in this order, and proceeds to step 16 to once finish this routine.

Namely, in step 12, the CPU actuates the starter 61 so, as to start cranking (STon). Then, in step 13, the CPU obtains the start-time water temperature THW. Then, in step 14, the CPU obtains the alcohol concentration E. Then, in step 15, the CPU resets a start-up completion flag (XST←0).

If, on the other hand, it is determined in step 11 that the state of ignition IG has not changed from OFF to ON, the CPU makes a negative decision (NO), and proceeds to step 16 to finish this routine.

(Fuel Injection Control Flow of First Embodiment)

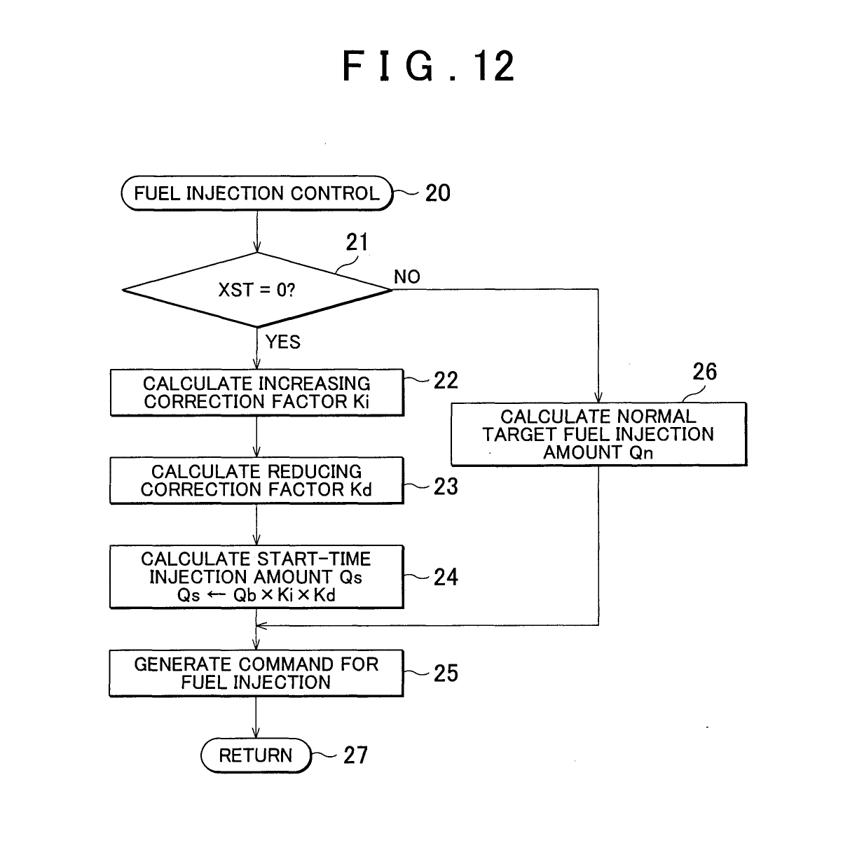

One example of fuel injection control flow of the first embodiment will be described. The example of flow, i.e., a fuel injection control routine, is illustrated in FIG. 12. The CPU repeatedly executes the routine of FIG. 12 with respect to any of the cylinders, each time the crank angle of the cylinder becomes equal to a given crank angle before the top dead center of the intake stroke. The given crank angle is, for example, 90° crank angle before the top dead center of the intake stroke. The cylinder of which the crank angle is equal to the given crank angle is also called “fuel injection cylinder”. The CPU calculates a specified fuel injection amount Qi, and gives a command for fuel injection, according to the fuel injection control routine.

If the crank angle of any cylinder becomes equal to the given crank angle before the intake top dead center, the CPU starts the routine of FIG. 12 from step 20, and determines in step 21 whether the start-up completion flag is reset (XST=0). If XST=0, the CPU makes an affirmative decision (YES), and executes step 22 through step 25 in this order. Then, the CPU proceeds to step 27 to once finish this routine.

Namely, in step 22, the CPU calculates the increasing correction factor Ki from the map of FIG. 2, based on the start-time water temperature THW and the alcohol concentration E. Then, in step 23, the CPU calculates the reducing correction factor Kd from the map of FIG. 3, based on the start-time water temperature THW and the alcohol concentration E. Then, in step 24, the CPU calculates the start-time injection amount Qs by multiplying the reference start-time injection amount Qb by the increasing correction factor Ki and the reducing correction factor Kd. Then, in step 25, the CPU sends a command signal for injecting the fuel from the fuel injection valve 33 in the start-time injection amount Qs, to the fuel injection valve 33.

If, on the other hand, XST=1, the CPU makes a negative decision (NO) in step 21, and executes step 26 and step 25 in this order. Then, the CPU proceeds to step 27 to once finish this routine.

Namely, in step 26, the CPU calculates a normal target fuel injection amount Qn. The normal target fuel injection amount Qn is a target fuel injection amount determined according to the engine speed and the engine load, in a period other than the start-up period. Then, in step 25, the CPU sends a command signal for injecting the fuel from the fuel injection valve 33 in the target fuel injection amount Qn, to the fuel injection valve 33.

(Start-Up Completion Determination Flow of First Embodiment)

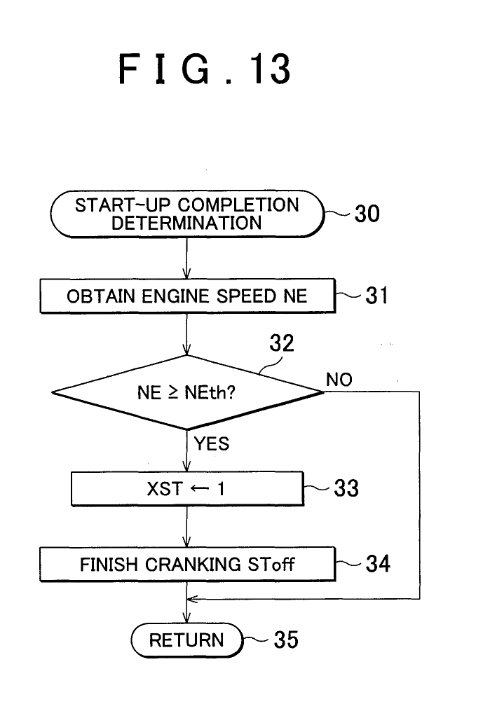

One example of start-up completion determination flow of the first embodiment will be described. The example of flow is illustrated in FIG. 13. The CPU repeatedly executes the routine of FIG. 13 at regular intervals, in synchronization of the time intervals of interrupt requests of the CPU. The CPU, starts the routine from step 30 at the right time, and obtains the engine speed NE in step 31.

Then, in step 32, the CPU determines whether the engine speed NE obtained in step 31 is equal to or higher than a given speed NEth (e.g., 700 rpm) (NE NEth). If NE is equal to or higher than NEth, the CPU makes an affirmative decision (YES), and executes step 33 and step 34 in this order. Then, the CPU proceeds to step 35 to once finish this routine.

Namely, in step 33, the CPU sets the start-up completion flag XST (XST 1). Then, in step 34, the CPU finishes cranking by stopping the operation of the starter 61 (SToff).

If, on the other hand, NE is not equal to nor higher than NEth, the CPU makes a negative decision (NO) in step 32, and proceeds to step 35 to finish this routine.

A second embodiment and a third embodiment will be described. The configuration and control of the second embodiment, which will not be described below, are respectively identical with those of the first embodiment, or are naturally derived from those of the first embodiment in view of the configuration and control of the second embodiment which will be described below.

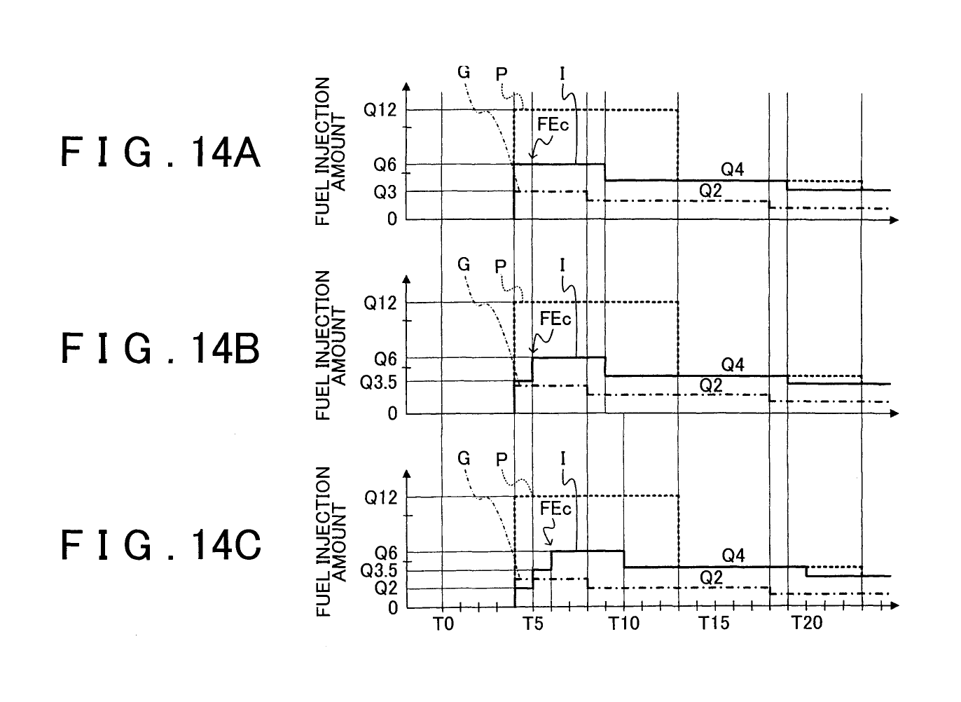

The control of the second embodiment and the third embodiment will be described. Changes in the fuel injection amount with time under the control of the second embodiment are indicated by the solid line in FIG. 14B, and changes in the fuel injection amount with time under the control of the third embodiment are indicated by the solid line in FIG. 14C. For reference, changes in the fuel injection amount with time under the control of the first embodiment are indicated by the solid line in FIG. 14A. In each of FIGS. 14A-14C, the one-dot chain line indicates changes in the fuel injection amount with time under the conventional gasoline control, and the dashed line indicates changes in the fuel injection amount with time under the conventional blended fuel control. These changes are identical with those shown in FIG. 10. The start-time water temperature is −25° C. In any of the cases, cranking is started at time TO, and the initial fuel injection is conducted at time T4. The first cycle is the cycle in which the initial fuel injection is conducted.

In FIGS. 14A, 14B, and 14C, the fuel injection amount has a relationship of Q2<Q3<Q3.5<Q4<Q6<Q12. The injection amount Q3 is the fuel injection amount of the first cycle under the conventional gasoline control. The injection amount Q12 is the fuel injection amount of the first cycle under the conventional blended fuel control.

<Control of Second Embodiment>

According to the control of the second embodiment, the fuel is injected in the injection amount Q3.5 in the first cycle (=time T4), as shown in FIG. 14B. In the second cycle (=time T5), the fuel is injected in the injection amount Q6. Namely, the fuel injection amount is increased. As in the first embodiment, since the fuel injection amount is small in the first cycle, the in-cylinder air-fuel ratio does not become a combustible air-fuel ratio, and the initial explosion does not occur. However, the fuel that is carried over from the first cycle to the second cycle is small. Also, even if the fuel injection amount is increased in the second cycle, to be larger than the fuel injection amount of the first cycle, the fuel injection amount is still sufficiently small. Accordingly, in the second cycle, the in-cylinder air-fuel ratio becomes a combustible air-fuel ratio, and the initial explosion occurs.

Then, the fuel injection amount is kept equal to the injection amount Q6 until it is determined that starting of the engine is completed (namely, until time T9). Then, if it is determined that starting of the engine is completed, the fuel injection amount is controlled to the injection amount Q4, as in the first embodiment. Namely, the fuel injection amount is reduced. Then, the fuel injection amount is kept equal to the injection amount Q4, until it is determined that the engine warm-up is completed (namely, until time T19). Then, if it is determined that the engine warm-up is completed, the fuel injection amount is controlled to the injection amount Q3.5. Namely, the fuel injection amount is further reduced.

According to the control as described above, the start-up completion time (=time T9) is later than the start-up completion time (=time T8) under the conventional gasoline control, but is significantly earlier than the start-up completion time (=time T13) under the conventional blended fuel control. Also, the start-up combustion period is substantially the same as the start-up combustion period under the conventional gasoline control, but is significantly shorter than the start-up combustion period under the conventional blended fuel control. Accordingly, the start-up time under the control of the second embodiment is slightly longer than the start-up time under the conventional gasoline control, but is significantly shorter than the start-up time under the conventional blended fuel control. This control is useful as a means for achieving the objective of reducing the start-up time, in the case where the proportion of the fuel that is carried over to the second cycle, in the fuel injected in the first cycle, is high.

<Control of Third Embodiment>

According to the control of the third embodiment, the fuel is injected in the injection amount Q2 in the first cycle (=time T4), as shown in FIG. 14C. In the second cycle (=time T5), the fuel is injected in the injection amount Q4. Namely, the fuel injection amount is increased. In the third cycle (=time T6), the fuel is injected in the injection amount Q6. Namely, the fuel injection amount is further increased. As in the first embodiment, since the fuel injection amount is considerably small in the first cycle, the in-cylinder air-fuel ratio does not become a combustible air-fuel ratio, and the initial explosion does not occur. Also, the fuel that is carried over from the first cycle to the second cycle is considerably small. While the fuel injection amount is increased in the second cycle, to be larger than the fuel injection amount of the first cycle, the fuel injection amount of the second cycle is still sufficiently small. Accordingly, in the second cycle, too, the in-cylinder air-fuel ratio does not become a combustible air-fuel ratio, and the initial explosion does not occur. Then, in the third cycle, the in-cylinder air-fuel ratio becomes a combustible air-fuel ratio for the first time, and the initial explosion occurs.

Then, the fuel injection amount is kept equal to the injection amount Q6 until it is determined that starting of the engine is completed (namely, until time T10). Then, if it is determined that starting of the engine is completed, the fuel injection amount is controlled to the injection amount Q4, as in the first embodiment. Namely, the fuel injection amount is reduced. Then, the fuel injection amount is kept equal to the injection amount Q4, until it is determined that the engine warm-up is completed (namely, until time T20). Then, if it is determined that the engine warm-up is completed, the fuel injection amount is controlled to the injection amount Q3.5. Namely, the fuel injection amount is further reduced.

According to the control as described above, the start-up completion time (=time T10) is later than the start-up completion time (=time T8) under the conventional gasoline control, but is significantly earlier than the start-up completion time (=time T13) under the conventional blended fuel control. Also, the start-up combustion period is slightly longer than the start-up combustion period under the conventional gasoline control, but is significantly shorter than the start-up combustion period under the conventional blended fuel control. Accordingly, the start-up time under the control of the third embodiment is slightly longer than the start-up time under the conventional gasoline control, but is significantly shorter than the start-up time under the conventional blended fuel control. This control is useful as a means for achieving the objective of reducing the start-up time, in the case where the proportion of the fuel that is carried over to the second cycle, in the fuel injected in the first cycle, is considerably high.

In the above-described embodiments, the fuel injection amount is kept constant from the occurrence of the initial explosion until the engine speed reaches the start-up completion speed. However, the fuel injection amount during this period may not be constant, but may be changed for each cycle, in view of characteristics of the internal combustion engine, so that the start-up time is minimized (or shortened by a permissible degree).

For example, if the initial explosion occurs, the in-cylinder temperature rapidly rises; therefore, the blended fuel is likely to evaporate, in cycles following the occurrence of the initial explosion. Therefore, if the fuel injection amount is kept constant even after the occurrence of the initial explosion, the in-cylinder air-fuel ratio may not become a combustible air-fuel ratio (namely, the in-cylinder air-fuel ratio may become an excessively rich air-fuel ratio). Thus, in this case, the fuel injection amount may be reduced after the occurrence of the initial explosion.

Since the blended fuel is likely to evaporate after the occurrence of the initial explosion, as described above, the fuel that is carried over to the next cycle is reduced. Therefore, if the fuel injection amount is kept constant even after the occurrence of the initial explosion, the in-cylinder air-fuel ratio may not become a combustible air-fuel ratio (namely, the in-cylinder air-fuel ratio may become an excessively lean air-fuel ratio). Thus, in this case, the fuel injection amount may be increased after the occurrence of the initial explosion.

In the above-described embodiments, the first fuel injection timing after the start of cranking is the same as the first fuel injection timing after the start of cranking under the conventional gasoline control and the conventional blended fuel control. However, in the above-described embodiments, this timing may be set to be earlier than the first fuel injection timing after the start of cranking under the conventional gasoline control and the conventional blended fuel control.

As described above, the fuel injection control system 80 of the internal combustion engine 10 is driven by the alcohol blended fuel. Also, the fuel injection control system 80 of the internal combustion engine 10 includes a controller (start-time injection amount controller 71) that controls the amount of the fuel injected from the fuel injection valve 33. When the alcohol concentration of the alcohol blended fuel is higher than a predetermined concentration, the controller 71 performs injection amount control after start of cranking so that the amount of the alcohol blended fuel injected from the fuel injection valve in each fuel injection is controlled to be smaller than an amount of the fuel with which the air-fuel ratio becomes a combustible air-fuel ratio, until the initial explosion occurs.

Further, in the fuel injection control system 80 of the internal combustion engine 10, the controller 71 sets the predetermined concentration to a higher concentration as the engine temperature is higher.

Further, in the fuel injection control system 80 of the internal combustion engine 10, the controller 71 increases the start-time injection amount (third predetermined amount) as the alcohol concentration is higher. The amount of increase of the start-time injection amount is an amount that makes up for a shortage of the amount of heat generated, due to a shortage of the evaporation amount of the alcohol blended fuel, relative to the amount of heat generated when the alcohol concentration is 0% (namely, when the fuel consists solely of gasoline), and the amount of heat lost due to vaporization of the alcohol component in the alcohol blended fuel.

Further, in the fuel injection control system 80 of the internal combustion engine. 10, the controller 71 performs the injection amount control, only when the alcohol concentration of the alcohol blended fuel is higher than the predetermined concentration, and the engine temperature is lower than a predetermined temperature.

Further, in the injection amount control, the controller 71 of the fuel injection control system 80 of the internal combustion engine 10 gradually increases the amount of the alcohol blended fuel injected from the fuel injection valve 33 in each fuel injection, within a range that is smaller than the amount of the fuel with which the air-fuel ratio becomes a combustible air-fuel ratio.

With the above arrangement, the in-cylinder air-fuel ratio is less likely or unlikely to be excessively rich after the initial explosion, and therefore, a short engine start-up time is achieved.

While ethanol is illustrated as an example of alcohol contained in the blended fuel, in the above-described embodiments, the fuel may contain another type of alcohol, such as methanol or butanol. While the engine coolant temperature measured upon the start of cranking is used as the start-time water temperature, in the above-described embodiments, the engine coolant temperature regularly obtained during the start-up period may be used.

What is claimed is:

1. A fuel injection control system of an internal combustion engine driven by an alcohol blended fuel, comprising:
a controller that controls an amount of the fuel injected from a fuel injection valve, the controller performing injection amount control after start of cranking, when an alcohol concentration of the alcohol blended fuel is higher than a predetermined concentration, so that the amount of the alcohol blended fuel injected from the fuel injection valve in each fuel injection is controlled to be smaller than an amount of the fuel with which an air-fuel ratio becomes a combustible air-fuel ratio, until an initial explosion occurs.

2. The fuel injection control system according to claim 1, wherein
the controller sets the predetermined concentration to a higher concentration as an engine temperature is higher.

3. The fuel injection control system according to claim 1, wherein the controller increases the start-time injection amount as the alcohol concentration is higher, an amount of increase of the start-time injection amount being an amount that makes up for a shortage of an amount of heat generated, due to a shortage of an evaporation amount of the alcohol blended fuel, relative to the amount of heat generated when the alcohol concentration is 0%, and an amount of heat lost due to vaporization of an alcohol component in the alcohol blended fuel.

4. The fuel injection control system according to claim 1, wherein the controller performs the injection amount control, only when the alcohol concentration of the alcohol blended fuel is higher than the predetermined concentration, and an engine temperature is lower than a predetermined temperature.

5. The fuel injection control system according to claim 1, wherein the controller gradually increases the amount of the alcohol blended fuel injected from the fuel injection valve in each fuel injection, within a range that is smaller than the amount of the fuel with which the air-fuel ratio becomes the combustible air-fuel ratio.
